(19) United States
(12) Patent Application Publication
(10) Pub. No.: US 2009/0114725 A1
(43) Pub. Date: May 7, 2009

(54) VALUE DOCUMENT, IN PARTICULAR A POSTAGE STAMP, WITH A SECURITY ELEMENT

(75) Inventors: Svetlozar Delianski, Berlin (DE); Thomas Jaeger, Berlin (DE); Georg Kinnemann, Bestensee (DE); Eberhard Rohm, Singen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/265,296

(22) Filed: Nov. 5, 2008

(30) Foreign Application Priority Data
Nov. 5, 2007 (DE) 10 2007 053 050.3
Dec. 6, 2007 (DE) 10 2007 058 679.7

(51) Int. Cl. G06K 7/10; G09F 3/00

(52) U.S. Cl. 235/454; 283/71

(57) ABSTRACT

A value document, in particular a postage stamp, which contains an optically recognizable security element in the form of a two-dimensional structure. Accordingly, the security element has a resolution of at least 300 dpi which makes it difficult to electronically reproduce the security element and therefore protect against the production of counterfeit postage stamps.

### CROSS-REFERENCE TO THE RELATED APPLICATIONS

This application claims the priority, under 35 U.S.C. § 119, of German applications DE 10 2007 053 050.3, filed Nov. 5, 2007, and DE 10 2007 058 679.7, filed Dec. 6, 2007; the prior applications are herewith incorporated by reference in their entireties.

### BACKGROUND OF THE INVENTION

### Field of the Invention

The invention relates to a value document, in particular a postage stamp, which contains an optically recognizable security element in the form of a two-dimensional structure.

Published, non-prosecuted German patent application DE 101 06 632 A1, corresponding to U.S. patent publication No. 20040105572 A1, teaches a value document being a postage stamp having a security element. In order to check whether or not the postal item has been provided with a genuine postage stamp, the presence of the security element is monitored.

Published, non-prosecuted German patent application DE 101 05 273 A1, corresponding to U.S. patent publication No. 20040096081, proposes the monitoring of a postal item as now described. Graphic information is captured from the surface of the postal item and is compared with stored graphic information. If the captured graphic information does not match the stored graphic information, the postal item is subjected to a detailed examination.

### SUMMARY OF THE INVENTION

It is accordingly an object of the invention to provide a value document, in particular a postage stamp, with a security element that overcome the above-mentioned disadvantages of the prior art devices and methods of this general type.

With the foregoing and other objects in view there is provided, in accordance with the invention, a value document. The value document contains an optically recognizable security element being in a form of a two-dimensional structure. The security element has a resolution of at least 300 dpi.

The invention relates to a value document, in particular a postage stamp, which contains an optically recognizable security element in the form of a two-dimensional structure. In accordance with the invention, the security element has a resolution of at least 300 dpi.

In a method for examining a value document, the value document is irradiated with light. The reflection of the light from the value document is captured, producing a digital image of the value document. The digital image has a resolution of at least 300 dpi. As a result, the digital image is automatically examined in order to determine whether or not it includes a specified security element in the form of the two-dimensional structure.

In order that the two-dimensional structure, when it is copied, is scanned identically from the original and produced on the copy, the structure of the security element must be scanned with a resolution of at least 2*300=600 dpi in accordance with the Nyquist-Shannon theorem. Scanners and photocopiers which are available today are not able to do this. Therefore, a two-dimensional structure with a resolution of at least 300 dpi cannot be copied with a scanner or a photocopier used today.

In accordance with an added feature of the invention, the security element has an encoding of information regarding the value document.

In accordance with another feature of the invention, the security element contains a matrix code or a bar code.

In accordance with an additional feature of the invention, the value document is a postage stamp.

With the foregoing and other objects in view there is further provided, in accordance with the invention, a method for examining a value document. The method includes aiming a beam of light at the value document and capturing a resulting reflection of the beam of light from the value document. The resulting reflection of the beam of light is captured such that an image of the value document is produced which has a resolution of at least 300 dpi. A test is carried out for determining if the resulting reflection contains an image of a specified security element having a form of a two-dimensional structure. The value document is considered genuine if the resulting reflection includes the image of the specified security element.

In accordance with an added mode of the invention, there is the step of providing the beam of light to consist of light in a visible spectrum.

With the foregoing and other objects in view there is provided, in accordance with the invention, a device for examining a value document. The device contains a light source configured for aiming a beam of light at the value document, and an image recording device configured for capturing a resulting reflection of the beam of light from the value document. The image recording device generates an image of the value document by capturing the resulting reflection. The image has a resolution of at least 300 dpi. An evaluation unit is configured to test if the resulting reflection contains an image of a specified security element being in a form of a two-dimensional structure, and if the resulting reflection includes the image of the specified security element, concluding that the value document is genuine.

In accordance with a concomitant feature of the invention, the evaluation unit has reading access to an electronic library containing at least one two-dimensional pattern and is configured to check during an examination of the image whether the resulting reflection contains a pattern which is at least the same as one pattern in the library.

Other features which are considered as characteristic for the invention are set forth in the appended claims.

Although the invention is illustrated and described herein as embodied in a value document, in particular a postage stamp, with a security element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is an illustration of a stamp with a two-dimensional security element according to the invention;

FIG. 2 is an illustration of a sectional enlargement of the stamp shown in FIG. 1; and

FIG. 3 is a block diagram of device for examining a value document.

### DETAILED DESCRIPTION OF THE INVENTION

In an exemplary embodiment, the value document is a stamp (“postage stamp”). The examination is carried out in a sorting facility. A postal item that has been provided with the stamp to be examined as a franking note passes through the sorting facility.

The examination is carried out in order to check whether or not the stamp on the postal item is genuine or counterfeit. Genuine stamps are those that were issued by a postal service provider. The postal service provider forwards the postal item and uses the sorting facility for this purpose, through which the postal item passes. Should the postal item be provided with a genuine stamp, the transport of the postal item has been prepaid, namely by the purchase of the stamp.

On the other hand, it is possible that a counterfeit stamp has been affixed to the postal item, i.e. with a two-dimensional reproduction of a stamp. The postal service provider received no income for the transport because the postal service provider did not sell this reproduction.

In the exemplary embodiment, the stamp has a security element in the form of a two-dimensional structure. The two-dimensional structure for example is in the form of a matrix code or a bar code. The security element preferably contains information about the stamp in encoded form, for example the face value of the stamp and, in addition, indications of the validity period of the stamp.

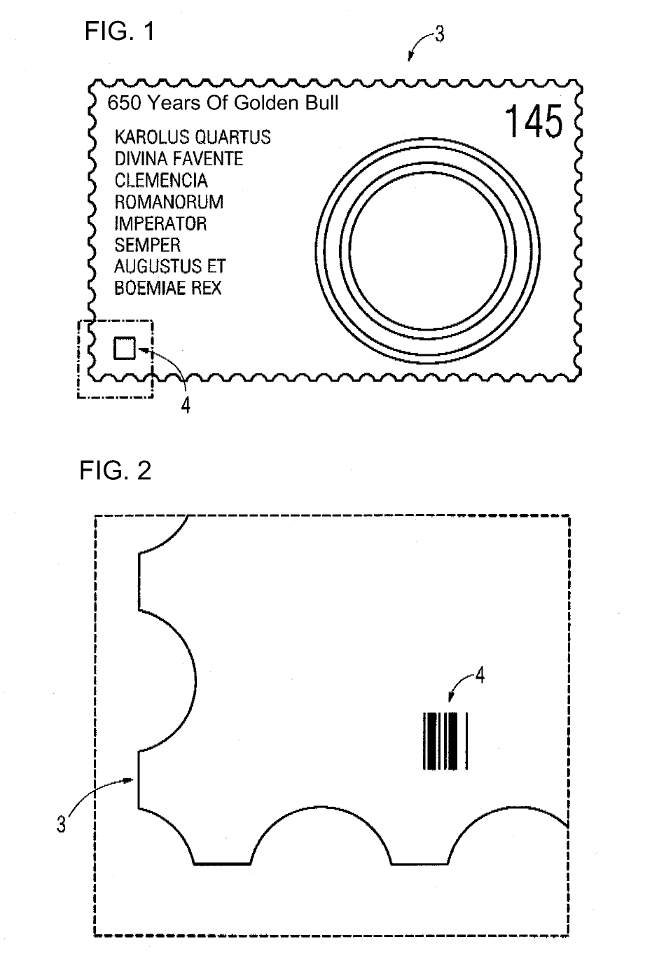

FIG. 1 shows by way of example a stamp 3. The area having a security element 4 is marked. FIG. 2 shows a sectional enlargement of the stamp in FIG. 1. A two-dimensional security element in the form of a bar code is shown in the bottom left corner. The bar code 4 is represented as excessively large. The security element 4 may also be in the form of a matrix code.

The security element 4 is printed during the manufacture of the stamp 3 or is also affixed afterwards in another manner. In accordance with the invention, the security element 4 has a resolution of at least 300 dots per inch (dpi). Its structure cannot be recognized with the naked eye. As a result, the security element 4 can only be copied or reproduced in another manner with great difficulty.

To this end, attempts are often made to counterfeit stamps by duplicating an original on a photocopier or on a scanner. In order that the two-dimensional structure is scanned in an identical manner from the original during such copying and is produced on the copy, the structure of the security element 4 must be scanned with a resolution of at least 2*300=600 dpi in accordance with the Nyquist-Shannon theorem. Scanners and photocopiers which are available today are not able to do this. Therefore, a two-dimensional structure with a resolution of at least 300 dpi cannot be copied with a scanner or a photocopier used today.

A reading device of the sorting facility produces a digital image of the postal item. This image contains an image of the stamp 1 and thus an image of the security element 2 with the encoded information. The encoded information is evaluated in order to decide for example whether or not sufficient postage has been paid on the postal item and whether or not the stamp 1 is currently still valid.

In an embodiment, the two-dimensional security element 2 is in addition used in order to locate the stamp 1 on the postal item and to distinguish it from other pictorial or graphic representations on the postal item.

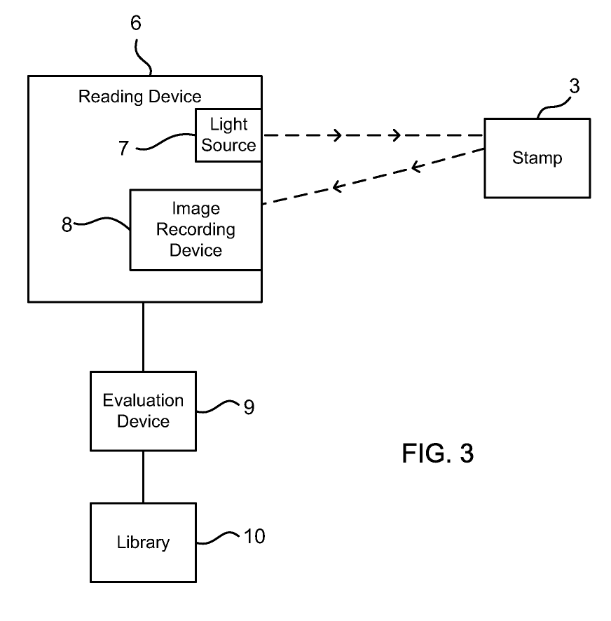

As shown in FIG. 3, a reading device 6 of the sorting facility has a light source 7 irradiating light on the postal item with the stamp for a short while and indeed preferably with light in the visible spectrum. Visible light here means electromagnetic radiation with a wavelength of approximately 380 to 780 nanometers (nm) and thus a frequency of approximately 789 down to 385 THz and can as a result be seen with the naked eye.

The reflection of the light from the postal item is recorded by an image recording device 7 and renders a digital image of the postal item. The digital image contains an image of the stamp 3. The reading device 6 scans the postal item to be examined in such a way that the digital image of the postal item has a resolution of at least 300 dpi. An evaluation unit 9 searches the digital image for the security element 4. If the evaluation unit 9 finds the security element 4 in the digital image, then the stamp 3 is genuine and the postal item is handled further. Otherwise, the postal item is removed and for example examined manually.

An electronic library 10 is preferably generated containing those two-dimensional patterns which are used as security elements. In an embodiment, a plurality of security elements is used in order to distinguish for example between the different levels of value of the stamps.

The evaluation unit 9 has reading access to the electronic library 10. The evaluation unit 9 is provided with an infrared image of the postal item. The evaluation unit 9 tests whether the security element image is contained in the resulting reflection of the infrared light. In this case, it carries out a comparison for each pattern in the library. The comparison includes the step of the evaluation unit 9 testing whether the reflection contains a pattern that is the same as this pattern from the library.

A theoretical value is preferably specified for the security element 4 on the stamp 3. The pattern from the library is scaled in such a manner that it is exactly as big as the actual size.

In an embodiment, a recognition system is trained using those two-dimensional structures which are printed onto the stamps. In the electronic library, those two-dimensional patterns are stored which are used as security elements. Furthermore, additional two-dimensional patterns are stored that are not used as security elements. The evaluation unit 9 is in addition informed of which two-dimensional structures are valid security elements and which are not. In that a method of machine learning is used, the recognition system is trained in such a way that it can automatically distinguish security elements from other two-dimensional structures.

1. A value document, comprising:
an optically recognizable security element being in a form of a two-dimensional structure, said security element having a resolution of at least 300 dpi.

2. The value document according to claim 1, wherein said security element has an encoding of information regarding the value document.

3. The value document according to claim 1, wherein said security element contains one of a matrix code and a bar code.

4. The value document according to claim 1, wherein the value document is a postage stamp.

5. A method for examining a value document, which comprises the steps of:
aiming a beam of light at the value document;
capturing a resulting reflection of the beam of light from the value document, the resulting reflection of the beam of light is captured such that an image of the value document is produced which has a resolution of at least 300 dpi;
carrying out a test for determining if the resulting reflection contains an image of a specified security element having a form of a two-dimensional structure; and
determining that the value document is genuine if the resulting reflection includes the image of the specified security element.

6. The method according to claim 5, which further comprises providing the beam of light to consist of light in a visible spectrum.

7. The method according to claim 5, wherein the value document is a postage stamp.

8. A device for examining a value document, the device comprising:
a light source configured for aiming a beam of light at the value document;
an image recording device configured for capturing a resulting reflection of the beam of light from the value document, said image recording device generating an image of the value document by capturing the resulting reflection, the image having a resolution of at least 300 dpi; and
an evaluation unit configured to test if the resulting reflection contains an image of a specified security element being in a form of a two-dimensional structure, and if the resulting reflection includes the image of the specified security element, concluding that the value document is genuine.

9. The device according to claim 8, wherein said evaluation unit has reading access to an electronic library containing at least one two-dimensional pattern and is configured to check during an examination of the image whether the resulting reflection contains a pattern which is at least the same as one pattern in the library.

10. The device according to claim 8, wherein the value document is a postage stamp.
